(19) United States
(12) Patent Application Publication
(10) Pub. No.: US 2021/0333922 A1
(43) Pub. Date: Oct. 28, 2021

(54) TOUCH DISPLAY PANEL AND DRIVE METHOD THEREOF, AND TOUCH DISPLAY DEVICE

(71) Applicants: HEFEI BOE OPTOELECTRONICS TECHNOLOGY CO., LTD., Hefei (CN); BOE TECHNOLOGY GROUP CO., LTD., Beijing (CN)

(72) Inventors: Zhixiang FANG, Beijing (CN); Jian HE, Beijing (CN)

(21) Appl. No.: 16/473,104

(22) PCT Filed: Jan. 4, 2019
(86) PCT No.: PCT/CN2019/070382

§ 371 Date: Jun. 24, 2019

(30) Foreign Application Priority Data
Jul. 2, 2018 (CN) 201810705810.5

(51) Int. Cl. G06F 3/041; G06F 3/044

(52) U.S. Cl. CPC G06F 3/0418; G06F 3/0446

(57) ABSTRACT

Embodiments of the present disclosure provide a touch display panel, a drive method, and a touch display device. The touch display panel includes a touch circuit, a determination circuit, and a display control circuit. The touch circuit may be configured to detect a touch signal. The determination circuit may be configured to determine a touch area of a touch region within an edge display region of the touch display panel according to the touch signal. The display control circuit may be configured to compare the touch area with a predetermined threshold, and control the touch display panel to display according to a comparison result, wherein a display function of the edge display region is maintained when the touch area is smaller than the predetermined threshold, and the display function of the edge display region is disabled when the touch area is larger than the predetermined threshold.

### CROSS REFERENCE TO RELATED APPLICATIONS

This patent application is a National Stage Entry of PCT/CN2019/070382 filed on Jan. 4, 2019, which claims the benefit and priority of Chinese Patent Application No. 201810705810.5 filed on Jul. 2, 2018, the disclosures of which are incorporated by reference herein in their entirety as part of the present application.

### BACKGROUND

The present disclosure relates to the field of touch and display technologies, and more particularly, to a touch display panel and a drive method thereof, and a touch display device.

With the rapid development of display technologies, touch display panels have been widely used in people's lives. Therefore, there is an increasing demand for large-size full-screen touch display panels.

### BRIEF DESCRIPTION

Embodiments of the present disclosure provide a touch display panel and a drive method thereof, and a touch display device.

A first aspect of the present disclosure provides a touch display panel. The touch display panel may include a touch circuit, a determination circuit, and a display control circuit. The touch circuit may be configured to detect a touch signal. The determination circuit may be configured to determine a touch area of a touch region within an edge display region of the touch display panel according to the touch signal. The display control circuit may be configured to compare the touch area with a predetermined threshold, and control the touch display panel to display according to a comparison result, wherein a display function of the edge display region is maintained when the touch area is smaller than the predetermined threshold, and the display function of the edge display region is disabled when the touch area is larger than the predetermined threshold.

In some embodiments of the present disclosure, the display control circuit may be further configured to adjust a size of a displayed image, in response to the display function of the edge display region being disabled, to adapt to a reduced display region.

In some embodiments of the present disclosure, the display control circuit may be further configured to disable a function of the edge display region when a duration of the touch area being larger than the predetermined threshold exceeds a designated duration.

In some embodiments of the present disclosure, the predetermined threshold is set to be between 1 cm² and 2 cm².

In some embodiments of the present disclosure, the touch display panel may include a self-capacitance touch electrode. The touch circuit may include a first capacitor, an amplifier, a reference capacitor, and an analog-to-digital converter. An end of the first capacitor is coupled to the self-capacitance touch electrode, and another end of the first capacitor is coupled to a common voltage terminal. A first input terminal of the amplifier is coupled to the self-capacitance touch electrode, and a second input terminal of the amplifier is coupled to a reference signal terminal. An end of the reference capacitor is coupled to the self-capacitance touch electrode, and another end of the reference capacitor is coupled to an output terminal of the amplifier. An input terminal of the analog-to-digital converter is coupled to an output terminal of the amplifier, and an output terminal of the analog-to-digital converter is configured to output the touch signal.

In some embodiments of the present disclosure, the determination circuit may be further configured to determine a location where the touch signal is greater than a touch threshold as a touch point, and a sequence of touch points constitute the touch region.

In some embodiments of the present disclosure, the touch display panel may include a drive touch electrode and a sense touch electrode. The touch circuit may include a second capacitor, an amplifier, a reference capacitor, and an analog-to-digital converter. The second capacitor is coupled between the drive touch electrode and the sense touch electrode. A first input terminal of the amplifier is coupled to the sense touch electrode, and a second input terminal of the amplifier is coupled to the reference signal terminal. An end of the reference capacitor is coupled to the sense touch electrode, and another end of the reference capacitor is coupled to the output terminal of the amplifier. An input terminal of the analog-to-digital converter is coupled to an output terminal of the amplifier, and an output terminal of the analog-to-digital converter is configured to output the touch signal.

In some embodiments of the present disclosure, the determination circuit may be further configured to determine a location where the touch signal is smaller than a touch threshold as a touch point, and a sequence of the touch points constitute the touch region.

A second aspect of the present disclosure provides a method for driving the touch display panel according to the first aspect of the present disclosure. In this method, a touch signal is detected, a touch area of a touch region within an edge display region of the touch display panel is determined according to the touch signal, the touch area is compared with a predetermined threshold, and the touch display panel is controlled to display according to a comparison result. A display function of the edge display region is maintained when the touch area is smaller than the predetermined threshold, and the display function of the edge display region is disabled when the touch area is larger than the predetermined threshold.

A third aspect of the present disclosure provides a touch display device. The touch display device includes the touch display panel according to the first aspect of the present disclosure.

According to some embodiments of the present disclosure, the touch display device is a full screen display device.

### BRIEF DESCRIPTION OF THE DRAWINGS

To describe the technical solutions of the present disclosure more clearly, the accompanying drawings of the embodiments will be briefly introduced below. It is to be known that the accompanying drawings in the following description merely involve some embodiments of the present disclosure, but do not limit the present disclosure, wherein the same reference numerals indicate the same elements or signals. In the drawings:

FIG. 1 illustrates a schematic diagram of a touch display panel according to an embodiment of the present disclosure;

FIG. 2 illustrates a schematic structural diagram of a touch display panel according to an embodiment of the present disclosure;

FIG. 3 illustrates an exemplary equivalent circuit diagram of a touch circuit of a self-capacitance touch display panel according to an embodiment of the present disclosure;

FIG. 4 illustrates an exemplary equivalent circuit diagram of a touch circuit of a mutual-capacitance touch display panel according to an embodiment of the present disclosure;

FIG. 5 illustrates a schematic diagram of touch signals in a touch display panel according to an embodiment of the present disclosure;

FIG. 6 illustrates a schematic diagram of displaying by the touch display panel according to the embodiment as shown in FIG. 5;

FIG. 7 illustrates a schematic diagram of touch signals in a touch display panel according to an embodiment of the present disclosure;

FIG. 8 illustrates a schematic diagram of displaying by the touch display panel according to the embodiment as shown in FIG. 7; and

FIG. 9 illustrates a schematic flowchart of a method for driving a touch display panel according to an embodiment of the present disclosure.

### DETAILED DESCRIPTION

To make technical solutions and advantages of the embodiments of the present disclosure clearer, the technical solutions in the embodiments of the present disclosure will be described clearly and completely below, in conjunction with the accompanying drawings. Apparently, the described embodiments are merely some but not all of the embodiments of the present disclosure. All other embodiments obtained by those of ordinary skill in the art based on the described embodiments without creative efforts shall fall within the protection scope of the present disclosure.

In the description of the present disclosure, unless otherwise stated, the term “a plurality of” means two or more than two, and the orientation or location relations represented by the terms of “above”, “below”, “left”, “right”, “inside”, “outside” and the like are orientation or location relations shown based on the accompanying figures, they are merely for ease of a description of the present disclosure and a simplified description instead of being intended to indicate or imply the device or element to have a special orientation or to be configured and operated in a special orientation. Thus, they cannot be understood as limiting of the present disclosure.

In the description of the present disclosure, it is to be noted that unless explicitly specified or limited otherwise, terms “installation”, “connecting”, or “coupling” should be understood in a broad sense, which may be, for example, a fixed connection, a detachable connection or integrated connection, a mechanical connection or an electrical connection, or a direct connection or indirect connection by means of an intermediary. For those of ordinary skill in the art, specific meanings of the above terms in the present disclosure may be understood based on specific circumstances.

FIG. 1 illustrates a schematic diagram of a touch display panel according to an embodiment of the present disclosure. As shown in FIG. 1, the touch display panel includes an active display region AA and a frame region BA. To obtain a better display effect, the area of the active display region AA may be increased, and the area of the frame region BA may be correspondingly reduced. In this way, a narrow bezel product or full screen product design may be implemented.

However, in the case where the area of the active display region AA is increased, when a user holds the touch display panel, the user may touch on an edge display region in the active display region AA. The edge display region is a region near an edge of the active display region AA, for example, a region extending by a certain distance (for example, about 1.5 cm) from the edge of the active display region AA to a center of the active display region AA. FIG. 1 schematically illustrates the edge display region of the active display region AA touched by fingers when the user holds the touch display panel. As shown in FIG. 1, the fingers may likely obstruct the displayed content. Therefore, it is easy to mistakenly trigger a function on the edge display region, thereby causing a maloperation.

Some embodiments of the present disclosure provide a touch display panel that may adjust a display mode according to a touch signal generated when a user touches the touch display panel. Therefore, obstruction and maloperation may be prevented.

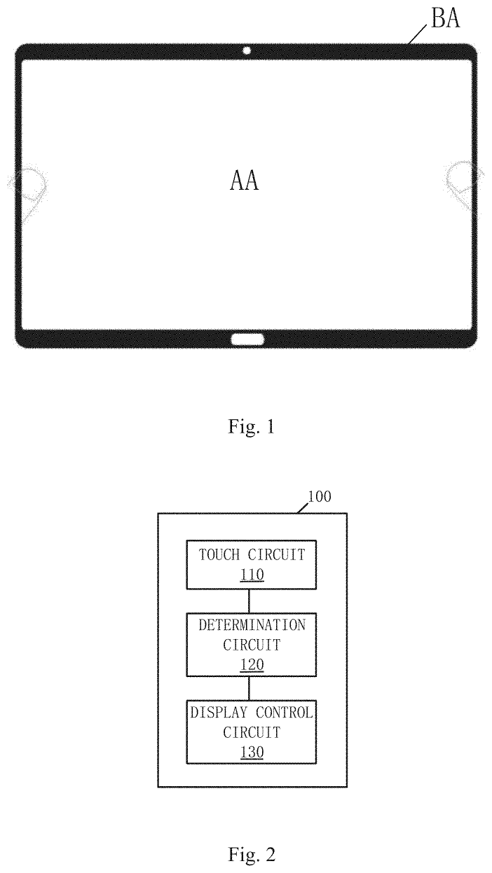

FIG. 2 illustrates a schematic block diagram of a touch display panel according to an embodiment of the present disclosure. As shown in FIG. 2, the touch display panel 100 may include a touch circuit 110, a determination circuit 120, and a display control circuit 130.

In some embodiments of the present disclosure, the touch circuit 110 may detect a touch signal. In some embodiments, the touch display panel 100 may be provided with a plurality of touch electrodes. The touch electrodes may be coupled to the respective touch circuits 110. When a human body (for example, a finger) is in contact with the touch display panel 100, a capacitance is formed between the human body and the touch electrode, such that the touch capacitance for the touch electrode is changed. The touch circuit 110 determines a touch signal associated with each touch electrode according to the change of the touch capacitance.

The determination circuit 120 may determine a touch region of the touch display panel 100 that is in contact with the human body according to the detected touch signal. When the touch region is located within the edge display region of the touch display panel 100, the determination circuit 120 may determine the touch area of the touch region within the edge display region. The determination circuit 120 may also be implemented by a processor or the like.

The display control circuit 130 may compare the determined touch area with a predetermined threshold. In some embodiments, the predetermined threshold may be set, for example, as an area close to a finger pulp of thumb. For example, the predetermined threshold may be set to be between about 1 cm² and about 2 cm². Next, the display control circuit 130 may control the touch display panel 100 to display according to a comparison result. For example, when the touch area is smaller than the predetermined threshold, the display control circuit 130 may control the touch display panel 100 to maintain a display function of the edge display region. When the touch area is larger than the predetermined threshold, the display control circuit 130 may control the touch display panel 100 to disable the display function of the edge display region. The display control circuit 130 may also be implemented by a processor or the like.

Generally, the contact area between the finger and the touch display panel is relatively small, when the user normally uses a touch function. However, when the user holds the touch display panel with one hand or both hands, in order to keep the touch display panel stable, the contact area between the finger and the touch display panel generally is relatively large. Although the user does not intent to perform the touch operation at this moment, it may still possibly cause maloperation of some function keys on the touch display panel and obstruction of a part of an image displayed on the touch display panel. Therefore, it may be determined whether the user is in a grip state based on the contact area between the finger and the touch display panel. In addition, after the finger stops touching the touch display panel, that is, after the contact area is reduced to 0, the full-screen display function of the touch display panel may be resumed.

Further, the display control circuit 130 may, in response to the display function of the edge display region being disabled, adjust a size of a displayed image, to adapt to a reduced display region.

In some embodiments, the display control circuit 130 may also disable a function of the edge display region when a duration of the determined touch area being larger than the predetermined threshold exceeds a designated duration. The designated duration may be set, for example, as about two seconds or the like. Therefore, the function of the edge display region may be disabled after the behavior of the user holding the touch display panel is stable.

In some embodiments of the present disclosure, the touch display panel may include a self-capacitance touch display panel and a mutual-capacitance touch display panel. For the self-capacitance touch display panel, the touch electrode may be a self-capacitance touch electrode. For the mutual-capacitance touch display panel, the touch electrode may be a drive touch electrode or a sense touch electrode.

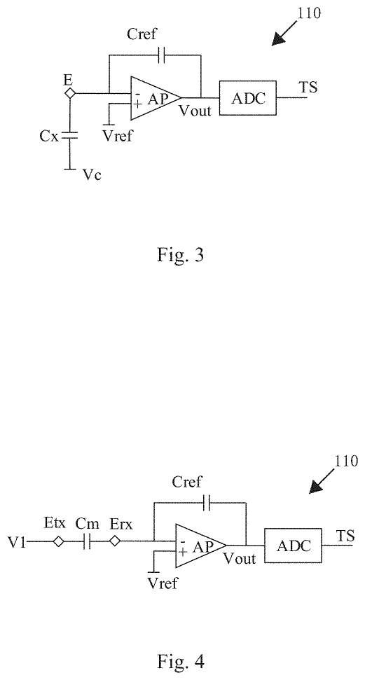

FIG. 3 illustrates an exemplary equivalent circuit diagram of a touch circuit of the self-capacitance touch display panel according to an embodiment of the present disclosure. As shown in FIG. 3, the touch circuit 110 may include, for example, a first capacitor Cx, an amplifier AP, a reference capacitor Cref, and an analog-to-digital converter ADC. An end of the first capacitor Cx is coupled to a self-capacitance touch electrode E, and another end of the first capacitor Cx is coupled to a common voltage terminal Vc. In some embodiments of the present disclosure, the first capacitor Cx may be a capacitor such as a coupling capacitor formed between the self-capacitance touch electrode E and the common voltage terminal Vc. A first input terminal of the amplifier AP is coupled to the self-capacitance touch electrode E, a second input terminal of the amplifier AP is coupled to a reference signal terminal Vref, and an output terminal of the amplifier AP outputs a detection signal Vout corresponding to the touch electrode. An end of the reference capacitor Cref is coupled to the self-capacitance touch electrode E, and another end of the reference capacitor Cref is coupled to an output terminal of the amplifier. An input terminal of the analog-to-digital converter ADC is coupled to the output terminal of the amplifier, and an output terminal of the analog-to-digital converter ADC is configured to output a touch signal TS (for example, a digital sense amount of the touch signal TS).

When the finger touches the touch display panel, the quantity of electric charges in the first capacitor Cx coupled to the self-capacitance touch electrode E at the touch location increases. The amplifier AP amplifies the quantity of electric charges to output a detection signal Vout. Then the analog-to-digital converter ADC converts the detection signal Vout into the digital sense amount of the touch signal TS. Correspondingly, when the finger does not touch the touch display panel, the quantity of electric charges in the first capacitor Cx is relatively small, and thus the digital sense amount of the touch signal TS outputted by the analog-to-digital converter ADC is relatively small. Therefore, when the digital sense amount of the touch signal TS detected at a certain location is greater than a touch threshold, the determination circuit 120 may determine this location as a touch point. When the digital sense amount of the touch signal TS detected at a certain location is smaller than the touch threshold, the determination circuit 120 may determine this location as a non-touch point.

FIG. 4 illustrates an exemplary equivalent circuit diagram of a touch circuit of a mutual-capacitance touch display panel according to an embodiment of the present disclosure. As shown in FIG. 4, the touch circuit 110 may include, for example, a second capacitor Cm, an amplifier AP, a reference capacitor Cref, and an analog-to-digital converter ADC. The second capacitor Cm is coupled between a drive touch electrode Etx and a sense touch electrode Erx. The drive touch electrode Etx is also coupled to a first voltage terminal V1. In some embodiments of the present disclosure, the second capacitor Cm may be a capacitor such as a coupling capacitor formed between the drive touch electrode Etx and the sense touch electrode Erx. A first input terminal of the amplifier AP is coupled to the sense touch electrode Erx, a second input terminal of the amplifier AP is coupled to a reference signal terminal Vref, and an output terminal of the amplifier AP outputs a detection signal Vout corresponding to the touch electrode. An end of the reference capacitor Cref is coupled to the sense touch electrode Erx, and another end of the reference capacitor Cref is coupled to the output terminal of the amplifier. An input terminal of the analog-to-digital converter ADC is coupled to an output terminal of the amplifier, and an output terminal of the analog-to-digital converter ADC is configured to output a touch signal TS (for example, a digital sense amount of the touch signal TS).

When the finger touches the touch display panel, the quantity of electric charges in the second capacitor Cm formed between the drive touch electrode Etx and the sense touch electrode Erx decreases at the touch location. Similar to the touch circuit in FIG. 3, the amplifier AP amplifies the quantity of electric charges to output a detection signal Vout. Then the analog-to-digital converter ADC converts the detection signal Vout into the digital sense amount of the touch signal TS. Correspondingly, when the finger does not touch the touch display panel, the quantity of electric charges in the second capacitor Cm is relatively large, and thus the digital sense amount of the touch signal TS outputted by the analog-to-digital converter ADC is relatively large. Therefore, in contrast to the self-capacitance touch display panel, for the mutual-capacitance touch display panel, when the digital sense amount of the touch signal TS detected at a certain location is smaller than the touch threshold, the determination circuit 120 may determine this location as a touch point. When the digital sense amount of the touch signal TS detected at a certain location is greater than the touch threshold, the determination circuit 120 may determine this location as a non-touch point.

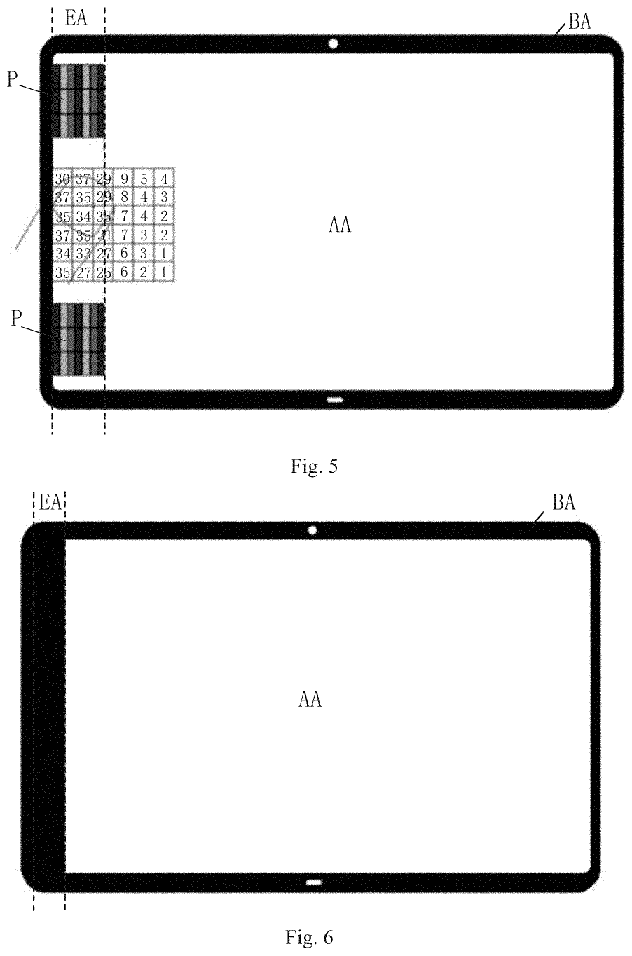

FIG. 5 illustrates a schematic diagram of touch signals in a touch display panel according to an embodiment of the present disclosure. In the embodiment of FIG. 5, an active display region AA and a frame region BA are schematically illustrated, and an edge display region EA, pixels P, and touch electrodes (illustrated by a block, digits thereon represent the digital sense amount of the touch signal of the touch electrode sensed) of the active display region AA are schematically illustrated. In some embodiments, the touch display panel as shown in FIG. 5 is a self-capacitance touch display panel.

As shown in FIG. 5, the finger touches the edge display region EA on a side (for example, the left side) of the touch display panel. The determination circuit 120 may determine a location where the digital sense amount of the touch signal TS is greater than the touch threshold (for example, the touch threshold is set to 29) as a touch point, and determine a location where the digital sense amount of the touch signal TS is smaller than the touch threshold as a non-touch point. In addition, the determination circuit 120 may determine that a sequence of touch points constitute the touch region, and thus may determine the touch area of the touch region in the edge display region EA. The display control circuit 130 may then disable the display function of the edge display region EA when the touch area is larger than a predetermined threshold (for example, the predetermined threshold may be set between 1 cm² and 2 cm²). It is to be understood that, in this case, if the area touched by the edge display region EA is too large, it may likely have a negative effect on the display of this region, or it is prone to causing a misoperation.

Those skilled in the art may understand that, in other embodiments, the touch display panel also may be a mutual-capacitance touch display panel. In such case, the determination circuit 120 may determine a location where the digital sense amount of the touch signal TS is smaller than the touch threshold as a touch point, and then determine a touch region and the touch area of this touch region in the edge display region.

FIG. 6 illustrates a schematic diagram of displaying by the touch display panel according to the embodiment as shown in FIG. 5. As shown in FIG. 6, the edge display region EA on the left side of the active display region AA does not display.

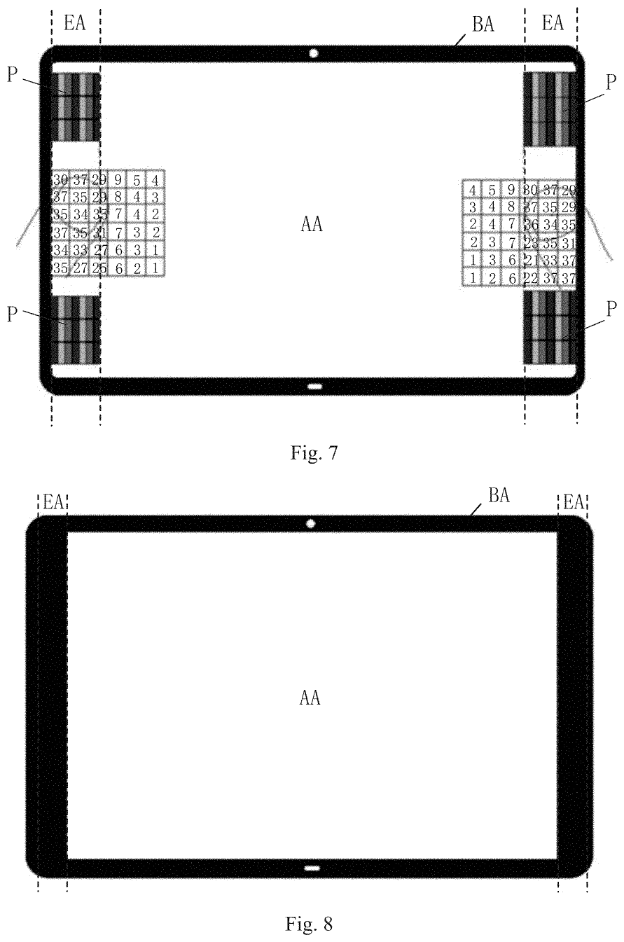

FIG. 7 illustrates a schematic diagram of a touch signal in a touch display panel according to another embodiment of the present disclosure. As shown in FIG. 7, both the left side and the right side of the touch display panel are touched. In the embodiment of FIG. 7, an active display region AA and a frame region BA are schematically illustrated. Moreover, edge display regions EA, pixels P, and touch electrodes (illustrated by a block, digits thereon represent the digital sense amount of the touch signal of the touch electrode sensed) on two sides of the active display region AA are schematically illustrated. In this embodiment, the touch display panel may be a self-capacitance touch display panel.

Similar to the embodiment of FIG. 5, the determination circuit 120 determines a location where the digital sense amount of the touch signal TS is greater than the touch threshold (for example, the touch threshold is set to 29) as a touch point. Sequences of touch points constitute the touch regions. Next, the determination circuit 120 determines the touch areas of the touch regions in the edge display regions EA. In this embodiment, the display control circuit 130 may disable the display function of the edge display regions EA when the respective touch area is larger than a predetermined threshold (for example, the predetermined threshold may be set between 1 cm² and 2 cm²).

Those skilled in the art may understand that, in other embodiments, the touch display panel also may be a mutual-capacitance touch display panel. In this case, the determination circuit 120 may determine a location where the digital sense amount of the touch signal TS is smaller than the touch threshold as a touch point, and then determine a touch region and the touch area of this touch region in the edge display region.

FIG. 8 illustrates a schematic diagram of displaying by the touch display panel according to the embodiment as shown in FIG. 7. As shown in FIG. 8, the edge display regions EA on two sides of the active display region AA do not display.

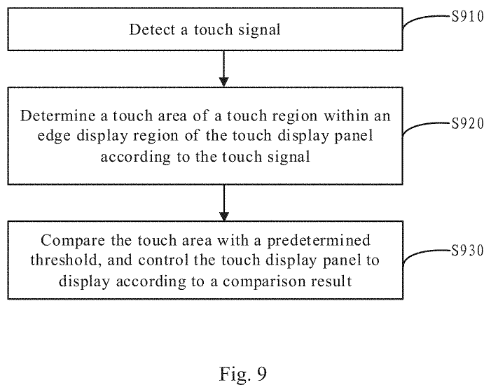

FIG. 9 illustrates a schematic flowchart of a method for driving a touch display panel according to an embodiment of the present disclosure.

As shown in FIG. 9, in Step S910, a touch signal is detected. In Step S920, a touch area of a touch region within an edge display region of the touch display panel is determined according to the touch signal. Next, in Step S930, the touch area is compared with a predetermined threshold, and the touch display panel is controlled to display according to a comparison result. A display function of the edge display region is maintained when the touch area is smaller than the predetermined threshold, and the display function of the edge display region is disabled when the touch area is larger than the predetermined threshold.

Embodiments of the present disclosure also provide a touch display device, which includes the above-described touch display panel. The touch display device may be, for example, a display screen, a mobile phone, a tablet computer, a camera, and a wearable device, etc. In some embodiments of the present disclosure, the touch display device may be a full screen display device.

A plurality of embodiments of the present disclosure are described in detail above. However, the scope of protection of the present disclosure is not limited thereto. Apparently, those of ordinary skill in the art may make various modifications, substitutions, and variations on some embodiments of the present disclosure without departing from the spirit and scope of the present disclosure. The scope of protection of the present disclosure is limited by the appended claims.

1. A touch display panel comprising:
a touch circuit configured to detect a touch signal;
a determination circuit configured to determine a touch area of a touch region within an edge display region of the touch display panel according to the touch signal; and
a display control circuit configured to compare the touch area with a predetermined threshold, and control the touch display panel to display according to a comparison result, wherein a display function of the edge display region is maintained when the touch area is smaller than the predetermined threshold, and wherein the display function of the edge display region is disabled when the touch area is larger than the predetermined threshold.

2. The touch display panel according to claim 1, wherein the display control circuit is further configured to adjust a size of a displayed image, in response to the display function of the edge display region being disabled, to adapt to a reduced display region.

3. The touch display panel according to claim 1, wherein the display control circuit is further configured to disable a function of the edge display region when a duration of the touch area larger than the predetermined threshold exceeds a designated duration.

4. The touch display panel according to claim 1, wherein the predetermined threshold is set to be between 1 cm² and 2 cm².

5. The touch display panel according to claim 1, wherein the touch display panel includes a self-capacitance touch electrode, and wherein the touch circuit comprises:
a first capacitor, wherein an end of the first capacitor is coupled to the self-capacitance touch electrode, and wherein another end of the first capacitor is coupled to a common voltage terminal;
an amplifier, wherein a first input terminal of the amplifier is coupled to the self-capacitance touch electrode, and wherein a second input terminal of the amplifier is coupled to a reference signal terminal;
a reference capacitor, wherein an end of the reference capacitor is coupled to the self-capacitance touch electrode, and wherein another end of the reference capacitor is coupled to an output terminal of the amplifier; and
an analog-to-digital converter, wherein an input terminal of the analog-to-digital converter is coupled to an output terminal of the amplifier, and wherein an output terminal of the analog-to-digital converter is configured to output the touch signal.

6. The touch display panel according to claim 5, wherein the determination circuit is further configured to determine a location where the touch signal is greater than a touch threshold as a touch point, and wherein a sequence of touch points constitute the touch region.

7. The touch display panel according to claim 1, wherein the touch display panel includes a drive touch electrode and a sense touch electrode, and wherein the touch circuit comprises:
a second capacitor, wherein the second capacitor is coupled between the drive touch electrode and the sense touch electrode;
an amplifier, wherein a first input terminal of the amplifier is coupled to the sense touch electrode, and wherein a second input terminal of the amplifier is coupled to the reference signal terminal;
a reference capacitor, wherein an end of the reference capacitor is coupled to the sense touch electrode, and wherein another end of the reference capacitor is coupled to the output terminal of the amplifier; and
an analog-to-digital converter, wherein an input terminal of the analog-to-digital converter is coupled to an output terminal of the amplifier, and wherein an output terminal of the analog-to-digital converter is configured to output the touch signal.

8. The touch display panel according to claim 7, wherein the determination circuit is further configured to determine a location where the touch signal is smaller than a touch threshold as a touch point, and wherein a sequence of the touch points constitute the touch region.

9. A method for driving the touch display panel according to claim 1, the method comprising:
detecting a touch signal;
determining a touch area of a touch region within an edge display region of the touch display panel according to the touch signal; and
comparing the touch area with a predetermined threshold, and controlling the touch display panel to display according to a comparison result, wherein a display function of the edge display region is maintained when the touch area is smaller than the predetermined threshold, and wherein the display function of the edge display region is disabled when the touch area is larger than the predetermined threshold.

10. A touch display device comprising the touch display panel according to claim 1.

11. The touch display device according to claim 10, wherein the touch display device is a full screen display device.

12. The touch display panel according to claim 2, wherein the touch display panel includes a self-capacitance touch electrode, and wherein the touch circuit comprises:
a first capacitor, wherein an end of the first capacitor is coupled to the self-capacitance touch electrode, and wherein another end of the first capacitor is coupled to a common voltage terminal;
an amplifier, wherein a first input terminal of the amplifier is coupled to the self-capacitance touch electrode, and wherein a second input terminal of the amplifier is coupled to a reference signal terminal;
a reference capacitor, wherein an end of the reference capacitor is coupled to the self-capacitance touch electrode, and wherein another end of the reference capacitor is coupled to an output terminal of the amplifier; and
an analog-to-digital converter, wherein an input terminal of the analog-to-digital converter is coupled to an output terminal of the amplifier, and wherein an output terminal of the analog-to-digital converter is configured to output the touch signal.

13. The touch display panel according to claim 12, wherein the determination circuit is further configured to determine a location where the touch signal is greater than a touch threshold as a touch point, and wherein a sequence of touch points constitute the touch region.

14. The touch display panel according to claim 3, wherein the touch display panel includes a self-capacitance touch electrode, and wherein the touch circuit comprises:
a first capacitor, wherein an end of the first capacitor is coupled to the self-capacitance touch electrode, and wherein another end of the first capacitor is coupled to a common voltage terminal;
an amplifier, wherein a first input terminal of the amplifier is coupled to the self-capacitance touch electrode, and wherein a second input terminal of the amplifier is coupled to a reference signal terminal;
a reference capacitor, wherein an end of the reference capacitor is coupled to the self-capacitance touch electrode, and wherein another end of the reference capacitor is coupled to an output terminal of the amplifier; and
an analog-to-digital converter, wherein an input terminal of the analog-to-digital converter is coupled to an output terminal of the amplifier, and wherein an output terminal of the analog-to-digital converter is configured to output the touch signal.

15. The touch display panel according to claim 14, wherein the determination circuit is further configured to determine a location where the touch signal is greater than a touch threshold as a touch point, and wherein a sequence of touch points constitute the touch region.

16. The touch display panel according to claim 2, wherein the touch display panel includes a drive touch electrode and a sense touch electrode, and wherein the touch circuit comprises:
a second capacitor, wherein the second capacitor is coupled between the drive touch electrode and the sense touch electrode;
an amplifier, wherein a first input terminal of the amplifier is coupled to the sense touch electrode, and wherein a second input terminal of the amplifier is coupled to the reference signal terminal;
a reference capacitor, wherein an end of the reference capacitor is coupled to the sense touch electrode, and wherein another end of the reference capacitor is coupled to the output terminal of the amplifier; and
an analog-to-digital converter, wherein an input terminal of the analog-to-digital converter is coupled to an output terminal of the amplifier, and wherein an output terminal of the analog-to-digital converter is configured to output the touch signal.

17. The touch display panel according to claim 16, wherein the determination circuit is further configured to determine a location where the touch signal is smaller than a touch threshold as a touch point, and wherein a sequence of the touch points constitute the touch region.

18. The touch display panel according to claim 3, wherein the touch display panel includes a drive touch electrode and a sense touch electrode, and wherein the touch circuit comprises:
a second capacitor, wherein the second capacitor is coupled between the drive touch electrode and the sense touch electrode;
an amplifier, wherein a first input terminal of the amplifier is coupled to the sense touch electrode, and wherein a second input terminal of the amplifier is coupled to the reference signal terminal;
a reference capacitor, wherein an end of the reference capacitor is coupled to the sense touch electrode, and wherein another end of the reference capacitor is coupled to the output terminal of the amplifier; and
an analog-to-digital converter, wherein an input terminal of the analog-to-digital converter is coupled to an output terminal of the amplifier, and wherein an output terminal of the analog-to-digital converter is configured to output the touch signal.

19. The touch display device according to claim 10, wherein a display control circuit of the touch display panel is further configured to adjust a size of a displayed image, in response to the display function of the edge display region being disabled, to adapt to a reduced display region.

20. The touch display device according to claim 10, wherein the display control circuit is further configured to disable a function of the edge display region when a duration of the touch area larger than the predetermined threshold exceeds a designated duration.
